(19) United States
(12) Patent Application Publication
(10) Pub. No.: US 2013/0066578 A1
(43) Pub. Date: Mar. 14, 2013

(54) METHOD AND DEVICE FOR DETERMINING ZERO-RATE OFFSET OF A GYROSCOPE, AND SYSTEM COMPRISING THE DEVICE

(71) Applicant: Travis Tu, Shanghai City (CN)

(72) Inventor: Travis Tu, Shanghai City (CN)

(73) Assignee: STMicroelectronics (China) Investment Co., Ltd., Shanghai (CN)

(21) Appl. No.: 13/615,158

(22) Filed: Sep. 13, 2012

(30) Foreign Application Priority Data
Sep. 14, 2011 (CN) 201110281440.5

(51) Int. Cl. G06F 19/00; G01C 25/00; G01C 19/00

(52) U.S. Cl. 702/87; 702/116

(57) ABSTRACT

The invention relates to a method of determining a zero-bias error of a gyroscope, an apparatus for determining a zero-bias error of a gyroscope and a system including the apparatus. The method includes the steps of: a. obtaining a set of outputs of the gyroscope; b. determining a dispersion degree of the outputs; c. determining whether the dispersion degree satisfies a predetermined condition and performing the step of d or e based upon a result of the determination; and d. determining an average of the outputs as the zero-bias error of the gyroscope when the dispersion degree satisfies the predetermined condition; or e. obtaining another set of outputs of the gyroscope and repeating performing the steps of b to c on the another set of outputs when the dispersion degree does not satisfy the predetermined condition.

### FIELD OF THE INVENTION

The present disclosure generally relates to a gyroscope and particularly to a method and apparatus for determining a zero-bias error of a gyroscope and a system including the apparatus.

### BACKGROUND OF THE INVENTION

A gyroscope, also referred to as an angular velocity meter, is typically used to detect the angular velocity and angle of rotation. Gyroscopes can be generally divided into traditional mechanical gyroscopes, sophisticated optic-fiber gyroscopes, laser gyroscopes and micromechanical gyroscopes in terms of different configurations and principles. The traditional mechanical gyroscopes, the sophisticated optic-fiber gyroscopes and the laser gyroscopes have been widely applied to navigation, guidance and control systems in aeronautics, astronautics and other military fields. The micromechanical gyroscopes have been widely applied in the field of customer electronics, for example, applied in the digital camera to stabilize the mage, in the inertial air mouse, etc., due to their characteristics of being easy to minimize, a low cost, etc.

However such a zero-bias phenomenon is typical for a gyroscope in a practical application that the output of the gyroscope at rest is not zero. FIG. 1 illustrates an example of a gyroscope with a zero bias, and as illustrated, the Y-axis output of the gyroscope placed at rest is not zero but drifts in the range of approximately 0 to −2 DPSs (Degrees Per Second) with an average of approximately −1.07 DPS. The precision of the system that adopts the gyroscope may be affected if this zero-bias error is not compensated for. For example, the air mouse typically outputs an XY coordinate signal based on the angular velocity of the gyroscope, and the cursor of the air mouse on the screen may drift or jitter at the time if the output of the gyroscope at rest is not zero. In another example, the attitude heading reference system (AHRS) displays attitude information of the heading angle, the elevation angle, the pitching angle, etc., of the aircraft based on the output of the gyroscope. The attitude information provided by the AHRS system may not be sufficiently accurate if the zero bias of the gyroscope is not compensated for. Therefore, it is desirable to compensate for the zero-bias error of the gyroscope.

One known compensation method is to place the gyroscope at rest, to record the current output of the gyroscope, to take the current output as the zero bias of the gyroscope and to subtract the zero bias from the actual output of the gyroscope in the subsequent process. However, this method suffers from such a problem that the current output may include the noise signal considerably deviating from the true value of the zero bias so that the derived zero bias may not be accurate. Another known compensation method is to set a threshold and to enable an output only if the output of the gyroscope exceeds the threshold; otherwise, to keep the gyroscope at rest. However the drawback of this method lies in its inapplicability to a precision-demanding scenario.

Moreover the zero-bias value of the gyroscope may also vary with changing ambient temperature or other factors. FIG. 2 illustrates a graph of an X-axis output, of a gyroscope of a specific model at rest, which varies with ambient temperature. As can be apparent from FIG. 2, the X-axis output of the gyroscope drifts by 8 DPSs due to an increase of 35° C. in temperature.

### SUMMARY OF THE INVENTION

In view of one or more of the foregoing problems:

In an aspect, the invention provides a method of determining a zero-bias error of a gyroscope, the method including the steps of: a. obtaining a set of outputs of the gyroscope; b. determining a dispersion degree of the outputs; c. determining whether the dispersion degree satisfies a predetermined condition and performing the step of d or e based upon a result of the determination; and d. determining an average of the outputs as the zero-bias error of the gyroscope when the dispersion degree satisfies the predetermined condition; or e. obtaining another set of outputs of the gyroscope and repeating performing the steps of b to c on the another set of outputs when the dispersion degree does not satisfy the predetermined condition.

In another aspect, the invention provides another method of determining a zero-bias error of a gyroscope, the method including the steps of: a. obtaining a set of outputs of the gyroscope; b. determining a dispersion degree of the outputs; c. determining whether the dispersion degree satisfies a predetermined condition and performing the step of d or e based upon a result of the determination; d. determining an average of the outputs as the zero-bias error of the gyroscope and updating the predetermined condition based upon the dispersion degree and further performing the step of f when the dispersion degree satisfies the predetermined condition; or e. performing the step of f directly when the dispersion degree does not satisfy the predetermined condition; and f. obtaining another set of outputs of the gyroscope and repeating performing the steps of b to f on the another set of outputs.

The foregoing description has outlined but not broadly presented the features of the disclosure. Additional features of the disclosure will be described hereinafter and form the subject of matter of the claims appended to the invention. Those skilled in the art shall appreciate that the disclosed idea and embodiments can be readily used as a basic to modify and design other structures or processes for achieving the same object as the invention. Those skilled in the art shall further appreciate that these equivalent structures will not depart from the gist and scope of the invention as recited in the appended claims.

### BRIEF DESCRIPTION OF DRAWINGS

In order to understand more fully the disclosure and advantages thereof, reference will be made now to the following description in connection with the drawings in which:

FIG. 1 illustrates a Y-axis output of a gyroscope with a zero bias at rest;

FIG. 2 illustrates an X-axis output, of a gyroscope at rest, varying with ambient temperature;

FIG. 3 illustrates a flow chart of an embodiment of a method of determining a zero-bias error of a gyroscope according to an aspect of the invention;

FIG. 4 illustrates a flow chart of a variation of the embodiment illustrated in FIG. 3;

FIG. 5 illustrates an example of sampling points of two adjacent sets of outputs in FIG. 3;

FIG. 6 illustrates another example of sampling points of two adjacent sets of outputs in FIG. 3;

FIG. 7 illustrates a flow chart of another embodiment of a method of determining a zero-bias error of a gyroscope according to an aspect of the invention;

FIG. 8 illustrates a flow chart of a variation of the embodiment illustrated in FIG. 7;

FIG. 9 illustrates a flow chart of another variation of the embodiment illustrated in

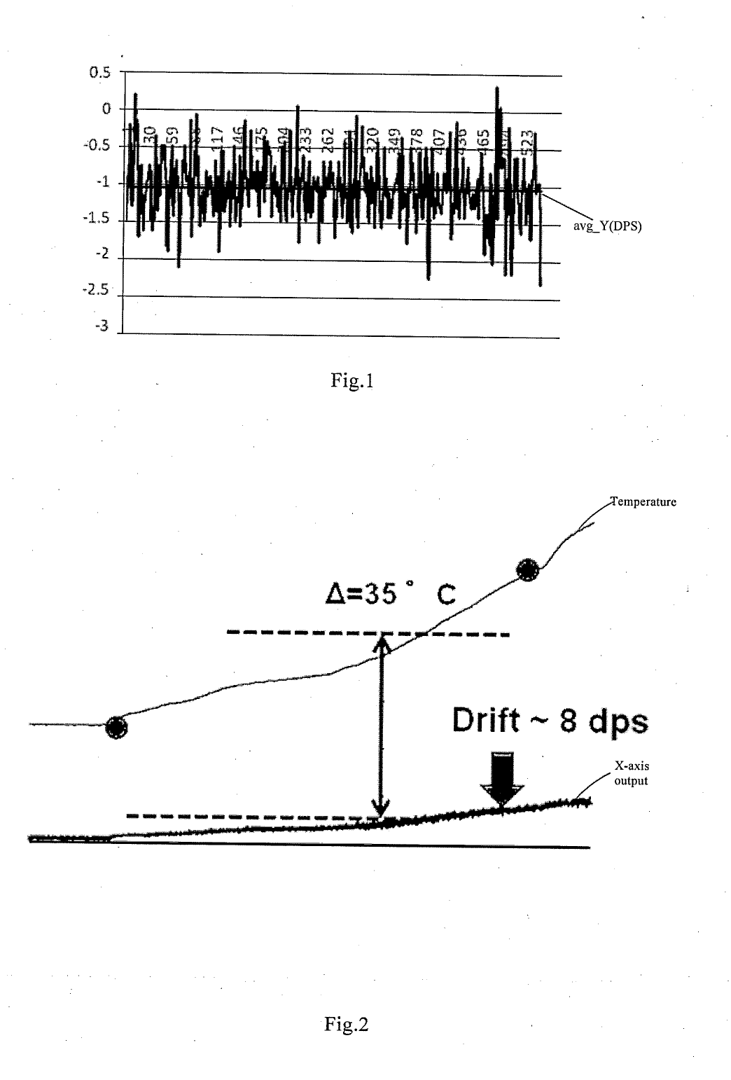

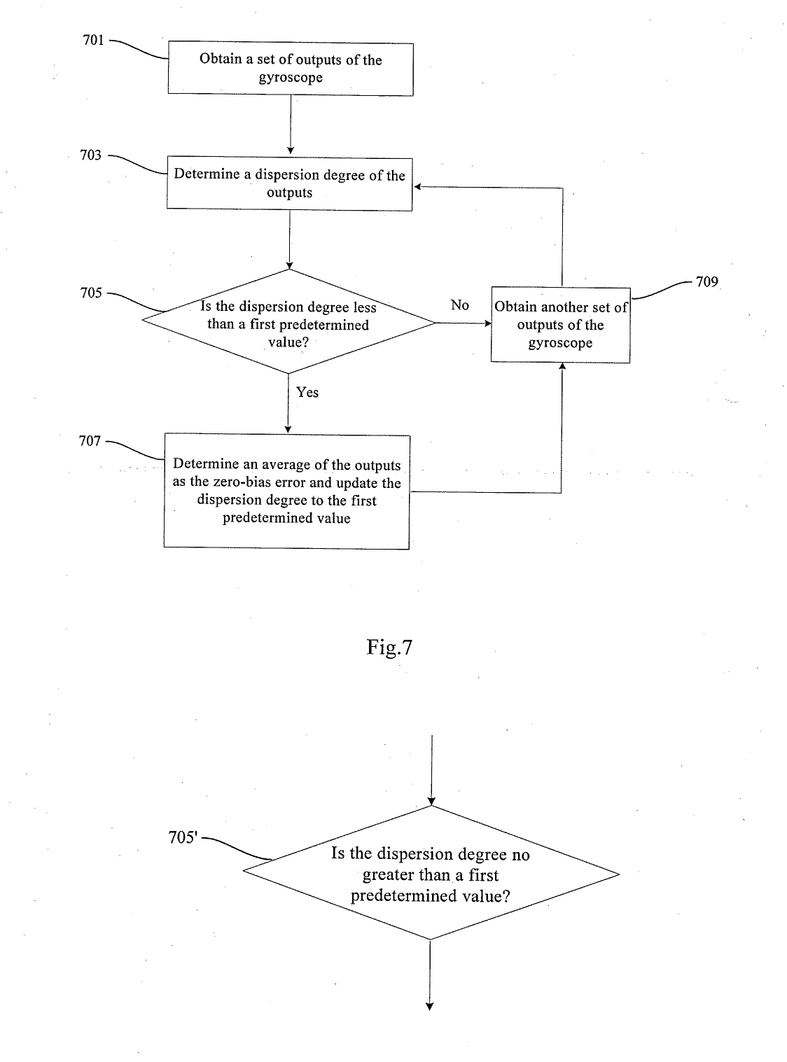

FIG. 7;

FIG. 10 illustrates a flow chart of another variation example of the embodiment illustrated in FIG. 7;

FIG. 11 illustrates a graph of a zero-bias error of a gyroscope determined in real time using the method in FIG. 10;

FIG. 12 illustrates a block diagram of an embodiment of an apparatus for determining a zero-bias error of a gyroscope according to another aspect of the invention;

FIG. 13 illustrates a system including the apparatus in FIG. 12;

FIG. 14 illustrates a block diagram of another embodiment of an apparatus for determining a zero-bias error of a gyroscope according to another aspect of the invention;

FIG. 15 illustrates a system including the apparatus in FIG. 14;

FIG. 16 illustrates a block diagram of another embodiment of an apparatus for determining a zero-bias error of a gyroscope according to another aspect of the invention;

FIG. 17 illustrates a system including the apparatus in FIG. 16;

FIG. 18 illustrates a block diagram of another embodiment of an apparatus for determining a zero-bias error of a gyroscope according to another aspect of the invention; and

FIG. 19 illustrates a system including the apparatus in FIG. 18.

Corresponding reference numerals and symbols in different figures generally denote corresponding parts unless stated otherwise. The drawings are drawn for the purpose of clearly illustrating relevant aspects of embodiments of the disclosure but not necessarily to scale. In order to more clearly illustrate some embodiments, a reference numeral may be followed by a letter to indicate a variant of the same structure, material or process step.

### DETAILED DESCRIPTION OF EMBODIMENTS

Implementations and uses of embodiments will be introduced below in details. However it shall be appreciated that the embodiments to be introduced will be merely intended to demonstratively describe specific modes in which the invention can be embodied and used but not to limit the scope of the invention.

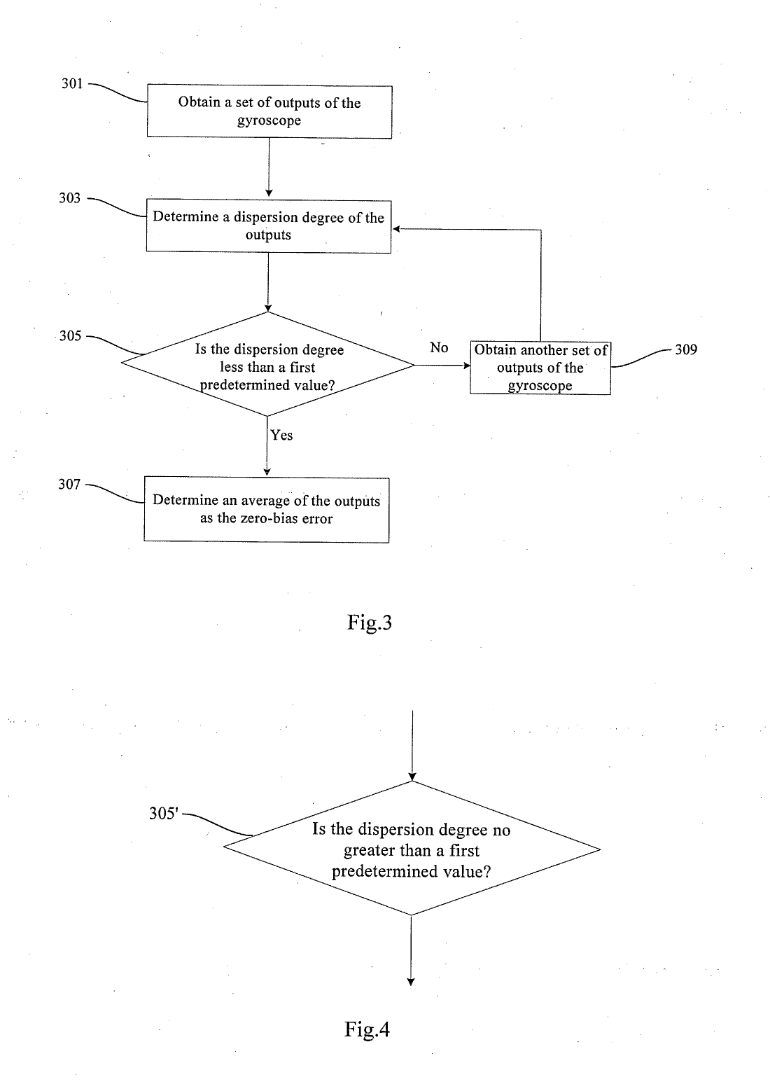

FIG. 3 illustrates a flow chart of an embodiment of a method of determining a zero-bias error of a gyroscope according to the invention. This embodiment will be described below with reference to FIG. 3.

A set of outputs of the gyroscope to be tested for a zero-bias error is obtained in the step 301. It shall be noted that the outputs can be read directly from the gyroscope or can be retrieved from a queue or stack of a memory coupled to the gyroscope. For example, a queue of a memory is used for storing the outputs of the gyroscope, and the outputs of the gyroscope are retrieved from the queue of the memory when a zero-bias error test is performed. Moreover the outputs of the gyroscope can be transmitted over a wired transmission medium, e.g., a cable, an optic fiber, etc., or can be transmitted over a wireless transmission medium, e.g., a microwave, etc.

Then a dispersion degree of the outputs is determined in the step 303. Those skilled in the art can appreciate that there can be various methods of characterizing the dispersion degree of a set of data, e.g., as a variance, a standard deviation, a sum of squares of deviation from mean, etc., and the dispersion degree of the outputs of the gyroscope can be determined in any method, of characterizing a dispersion degree of data, as known or as developed after the filing date of this invention. In an example, a set of outputs of the gyroscope includes 10 sampling points {X1, X2, . . . , X10}, and the dispersion degree of this set of outputs is determined using a standard deviation, where the dispersion degree α is represented in the equation of:

$$α = \sqrt{{\sum }_{i = 1}^{10} {( Xi - X )}^{2} / 9} ,$$

Where X is an arithmetic mean of these 10 sampling points.

Next it is determined in the step 305 whether the dispersion degree satisfies a predetermined condition. In this flow chart, the step 305 is illustrated as determining whether the dispersion degree is less than a first predetermined value, so the predetermined condition is being less than the first predetermined value in this example, wherein the first predetermined value can be a constant determined as needed in practice. For example, the first predetermined value can be set relatively small, that is, the predetermined condition is relatively strict, in the case that it is required that a zero-bias test can be performed on the gyroscope only if it is at “absolute” rest; and it will be considered that the gyroscope is not at sufficient rest or that there is considerable interference around if the dispersion degree of the outputs is greater than the first predetermined value, and thus no zero-bias test will be performed on the gyroscope. The first predetermined value can be set relatively large, that is, the predetermined condition is relatively loose, in the case that it is required that a zero-bias test can be performed on the gyroscope as long as it is at “almost” rest.

The step 307 is performed to determine an average of the outputs as the zero-bias error of the gyroscope if the predetermined condition is satisfied, that is, the dispersion degree is less than the first threshold, based on the result of the determination in the step 305, wherein the average of the outputs can be, for example, an arithmetic mean of the set of outputs, and those ordinarily skilled in the art can appreciate that the average here can be any mathematic quantity, representing an average of a set of data, as known or as developed after the filing date of this invention.

On the contrary, the step 309 is performed to obtain another set of outputs of the gyroscope and to repeat performing the foregoing steps 303 to 305 on the another set of outputs if the predetermined condition is not satisfied, that is, the dispersion degree is greater than or equal to the first threshold. A relationship between the another set of outputs and the previous set of outputs will be described below in details.

In the embodiment illustrated in FIG. 3, it is determined whether the dispersion degree of a set of outputs satisfies a predetermined condition, so the method of determining a zero-bias error of a gyroscope can be applicable to scenarios with different test requirements by changing the predetermined condition, that is, the method has greater flexibility.

Moreover the dispersion degree of a set of outputs is determined to thereby prevent excessive noise from being introduced to the outputs due to mechanical vibration, electromagnetic interference and other reasons, thus ensuring that the set of outputs reflects a rest status without any occasional event occurring and thus a derived zero-bias error is closer to a true value.

It shall be noted that the predetermined condition can be in various forms, and FIG. 4 illustrates a variation of the embodiment illustrated in FIG. 3, wherein FIG. 4 differs from FIG. 3 in that it is determined in the step 305′ whether the dispersion degree of the outputs of the gyroscope is no greater than a first predetermined value.

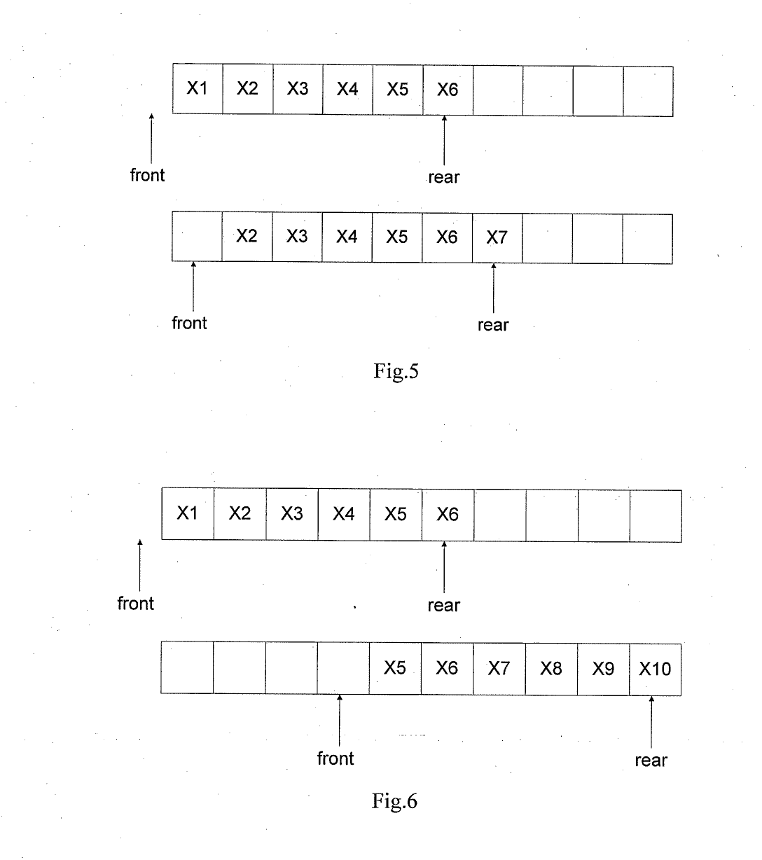

A relationship between sampling points of two adjacent sets of outputs will be described in details below in connection with FIG. 5 and FIG. 6.

As illustrated in FIG. 5, a set of outputs of the gyroscope obtained, for example, in the step 301 of FIG. 3 is stored in a queue as elements X1, X2, . . . , X6, and another set of outputs of the gyroscope is obtained if the dispersion degree of X1, X2, . . . , X6 does not satisfy a predetermined condition, for example, is no less than a first predetermined value. Particularly X1 is dequeued out of the queue and X7 is queued into the queue so that the elements X2, X3, . . . , X7 constitute the another set of outputs, where X1, X2, . . . , X7 correspond respectively to angular velocities output sequentially from the gyroscope. The sampling points X2, X3, . . . , X6 are identical in these two adjacent sets of outputs.

FIG. 6 illustrates another example of two adjacent sets of outputs in FIG. 3. A set of outputs of the gyroscope obtained, for example, in the step 301 of FIG. 3 is stored in a queue as elements X1, X2, . . . , X6, and another set of outputs of the gyroscope is obtained if the dispersion degree of X1, X2, . . . , X6 does not satisfy a predetermined condition, for example, is no less than a first predetermined value. Particularly X1, X2, X3 and X4 are out of the queue, and X7, X8, X9 and X10 are queued into the queue so that the elements X5, X6, . . . , X10 constitute the another set of outputs, where X1, X2, X10 correspond respectively to angular velocities output sequentially from the gyroscope. Only the sampling points X5 and X6 are identical in these two adjacent sets of outputs.

Those skilled in the art can appreciate that the two adjacent sets of outputs can be totally different.

FIG. 7 illustrates a flow chart of another embodiment of a method of determining a zero-bias error of a gyroscope according to the invention. This embodiment will be described with reference to FIG. 7.

A set of outputs of the gyroscope to be tested for a zero-bias error is obtained in the step 701. It shall be noted that the outputs can be read directly from the gyroscope or can be retrieved from a queue or stack of a memory coupled to the gyroscope, for example, a queue of a memory is used for storing the outputs of the gyroscope, and the outputs of the gyroscope are retrieved from the queue of the memory when a zero-bias error test is performed. Moreover the outputs of the gyroscope can be transmitted over a wired transmission medium, e.g., a cable, an optic fiber, etc., or can be transmitted over a wireless transmission medium, e.g., a microwave, etc.

Then a dispersion degree of the outputs is determined in the step 703. Those skilled in the art can appreciate that there can be various methods of characterizing the dispersion degree of a set of data, e.g., as a variance, a standard deviation, a sum of squares of deviation from mean, etc., and the dispersion degree of the outputs of the gyroscope can be determined in any method, of characterizing a dispersion degree of data, as known or as developed after the filing date of this invention. In an example, a set of outputs of the gyroscope includes 10 sampling points {X1, X2, . . . , X10}, and the dispersion degree of this set of outputs is determined using a standard deviation, where the dispersion degree α is represented in the equation of:

$$α = \sqrt{{\sum }_{i = 1}^{10} {( Xi - X )}^{2} / 9} ,$$

Where X is an arithmetic mean of these 10 sampling points.

Next it is determined in the step 705 whether the dispersion degree satisfies a predetermined condition. In this flow chart, the step 705 is illustrated as determining whether the dispersion degree is less than a first predetermined value, so the predetermined condition is being less than the first predetermined value in this example, wherein the first predetermined value can be a constant determined as needed in practice. For example, the first predetermined value can be set relatively small, that is, the predetermined condition is relatively strict, in the case that it is required that a zero-bias test can be performed on the gyroscope only if it is at “absolute” rest; and it will be considered that the gyroscope is not at sufficient rest or that there is considerable interference around if the dispersion degree of the outputs is greater than the first predetermined value, and thus no zero-bias test will be performed on the gyroscope. The first predetermined value can be set relatively large, that is, the predetermined condition is relatively loose, in the case that it is required that a zero-bias test can be performed on the gyroscope as long as it is at “almost” rest.

The step 707 is performed to determine an average of the outputs as the zero-bias error of the gyroscope and to update the predetermined condition based on the dispersion degree if the predetermined condition is satisfied based on the result of the determination in the step 705, wherein when the predetermined condition is being less than a first predetermined value, the predetermined condition is updated based on the dispersion degree by updating the first predetermined value with the dispersion degree, wherein the average of the outputs can be, for example, an arithmetic mean of the set of outputs, and those ordinarily skilled in the art can appreciate that the average here can be any mathematic quantity, representing an average of a set of data, as known or as developed after the filing date of this invention. The step 709 is further performed, subsequent to the performing of the step 707, to obtain another set of outputs of the gyroscope and to repeat performing the foregoing steps 703 to 705 on the another set of outputs.

The step 709 is performed to obtain another set of outputs of the gyroscope and to repeat performing the foregoing steps 703 to 705 on the another set of outputs if the predetermined condition is not satisfied based on the result of the determination in the step 705.

In the embodiment illustrated in FIG. 7, it is determined whether the dispersion degree of a set of outputs satisfies a predetermined condition, so the method of determining a zero-bias error of a gyroscope can be applicable to scenarios with different test requirements by changing the predetermined condition, that is, the method has greater flexibility.

Moreover the dispersion degree of a set of outputs is determined to thereby prevent excessive noise from being introduced to the outputs due to mechanical vibration, electromagnetic interference and other reasons, thus ensuring that the set of outputs reflects a rest status without any occasional event occurring and thus a derived zero-bias error is closer to a true value.

Moreover this method allows a test to be started on the gyroscope still in motion, and the zero-bias error derived with this method will constantly approach a true value as the gyroscope approaches rest. This process will be described in details as follows: the first predetermined value is set infinite or sufficiently large, and thus it is determined in the step 705 that the dispersion degree of the outputs of the gyroscope is less than the first predetermined value and thereby in the step 707 the first predetermined value is defined as the dispersion degree of the outputs and the average of the outputs is determined as the zero-bias error. If the gyroscope approaches rest, the dispersion degree of the subsequently obtained set of outputs of the gyroscope will be smaller and smaller until the gyroscope comes to rest and the dispersion degree reaches the minimum. In the step 707, the first predetermined value is defined as the minimum dispersion degree of the outputs and the average of the outputs corresponding to this status is determined as the zero-bias error. If the gyroscope subsequently goes back to instability, the dispersion degree of the outputs of the gyroscope is larger than the first predetermined value, and thus the zero-bias error will be maintained at the average of the outputs of the gyroscope at rest.

Moreover this method can be used to determine a zero-bias error of a gyroscope in real time, and this method can track a change in the zero-bias error of the gyroscope in the case that the zero-bias error of the gyroscope becomes smaller, for example, in the case that the peripheral circuit of the gyroscope is replaced or in the case of lowered ambient temperature.

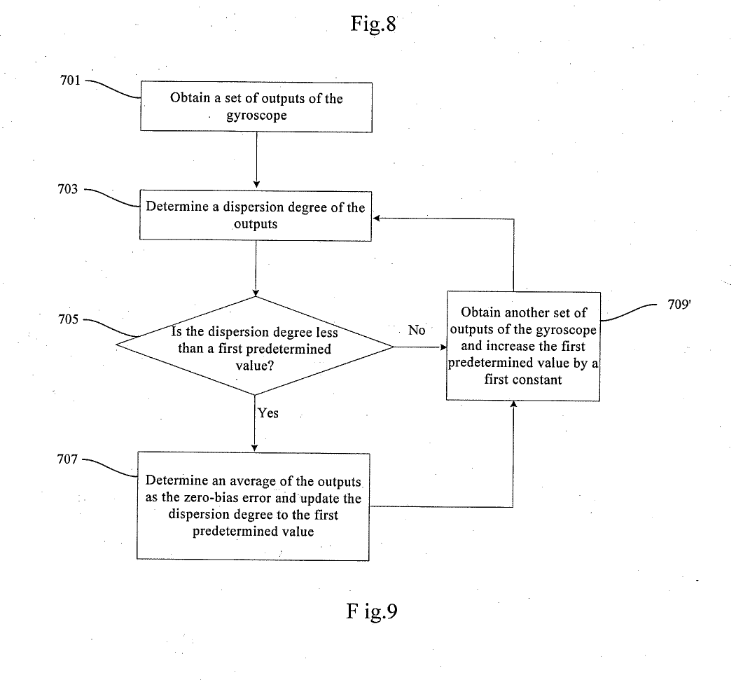

It shall be noted that the predetermined condition can be in various forms, and FIG. 8 illustrates a variation of the embodiment illustrated in FIG. 7, wherein FIG. 8 differs from FIG. 7 in that it is determined in the step 705′ whether the dispersion degree of the outputs of the gyroscope is no greater than a first predetermined value.

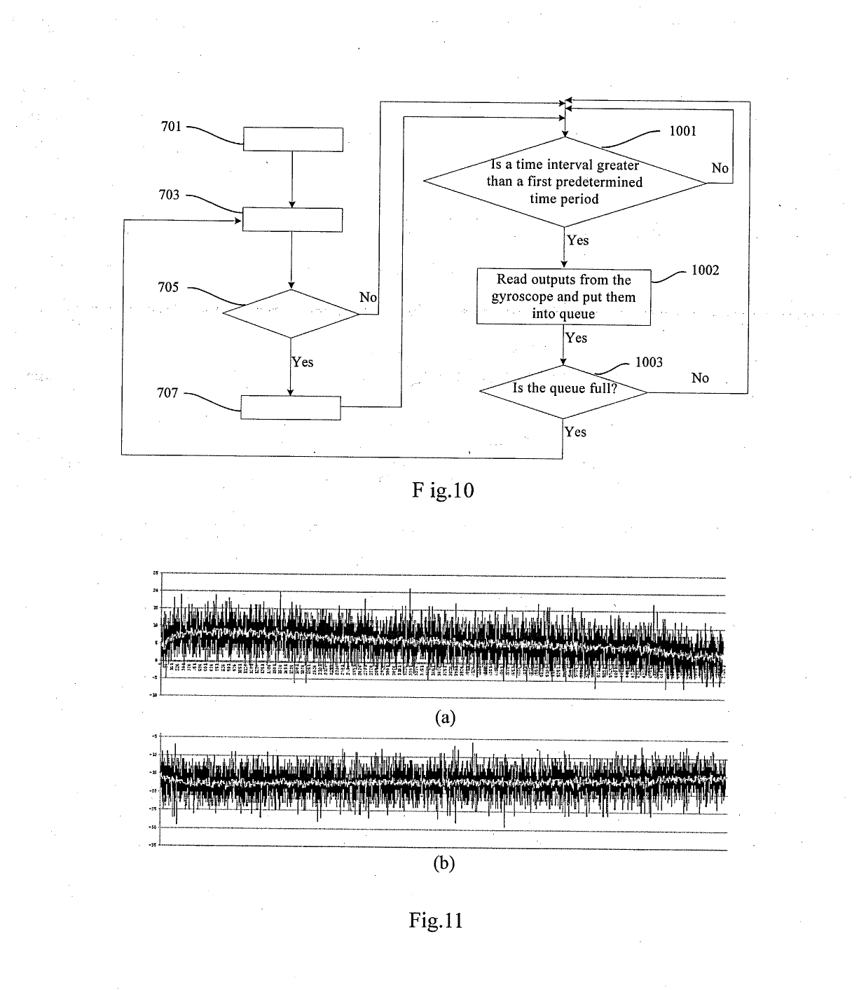

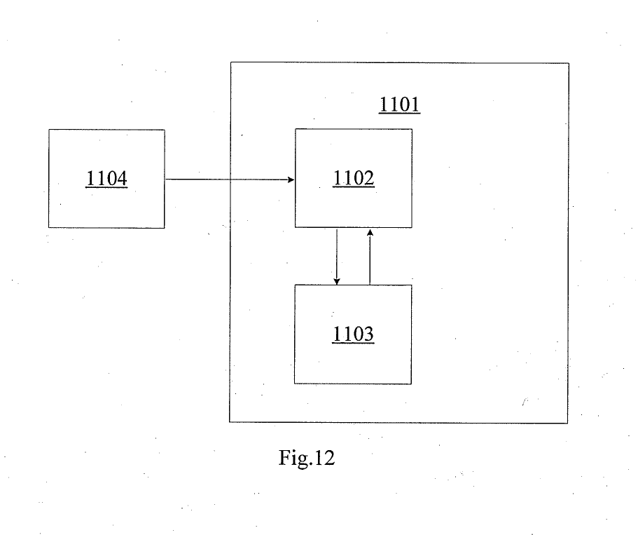

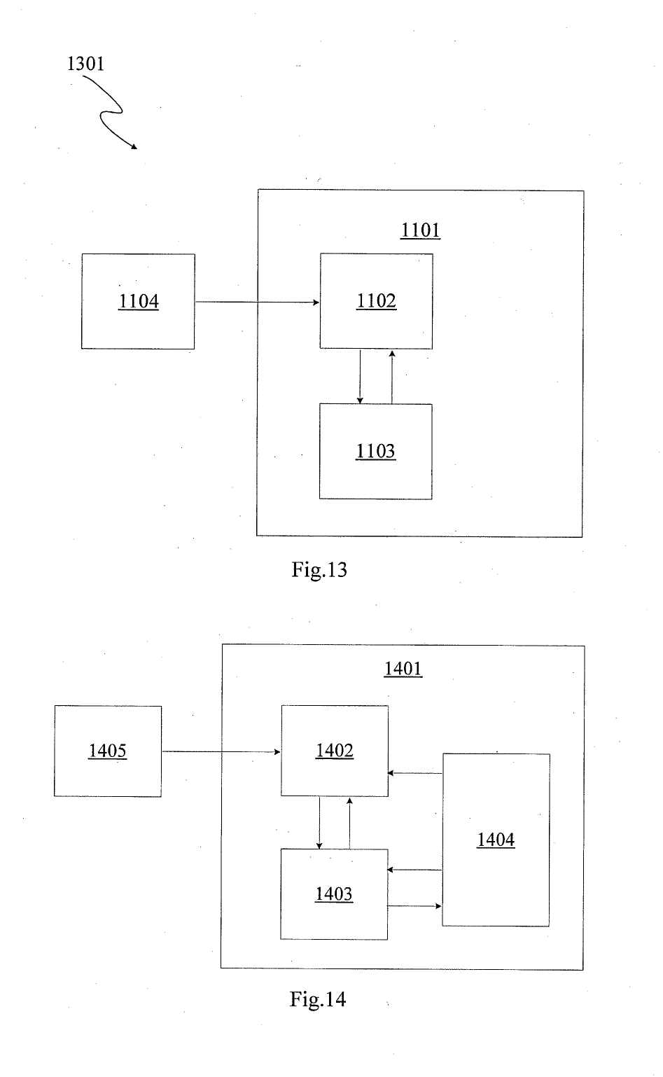

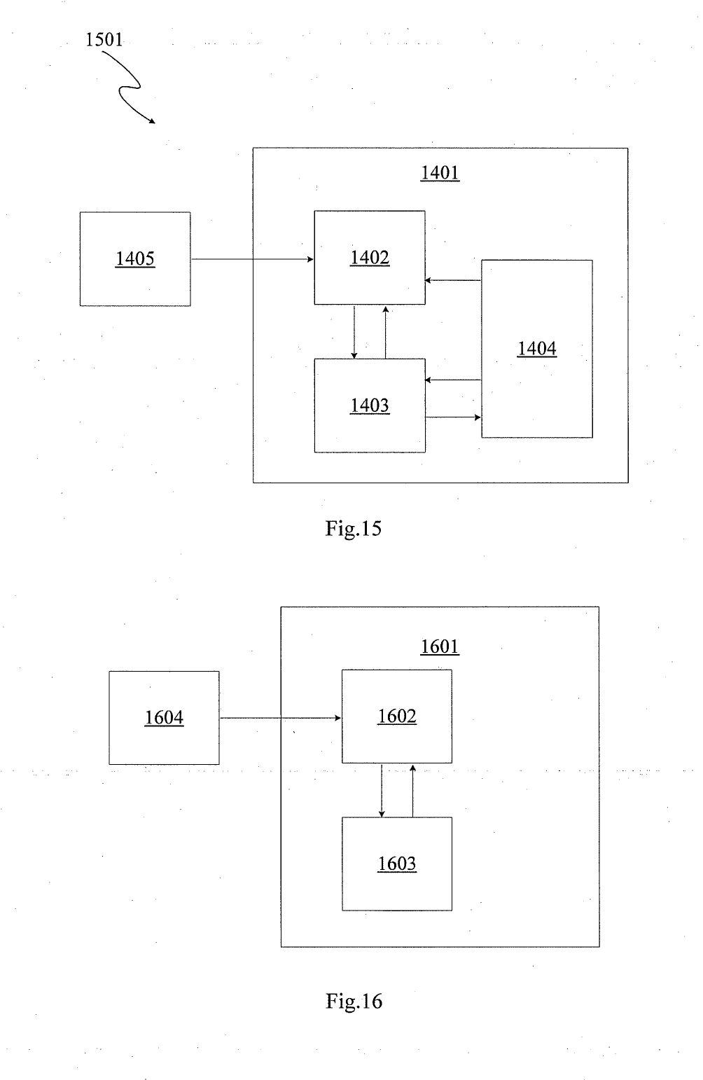

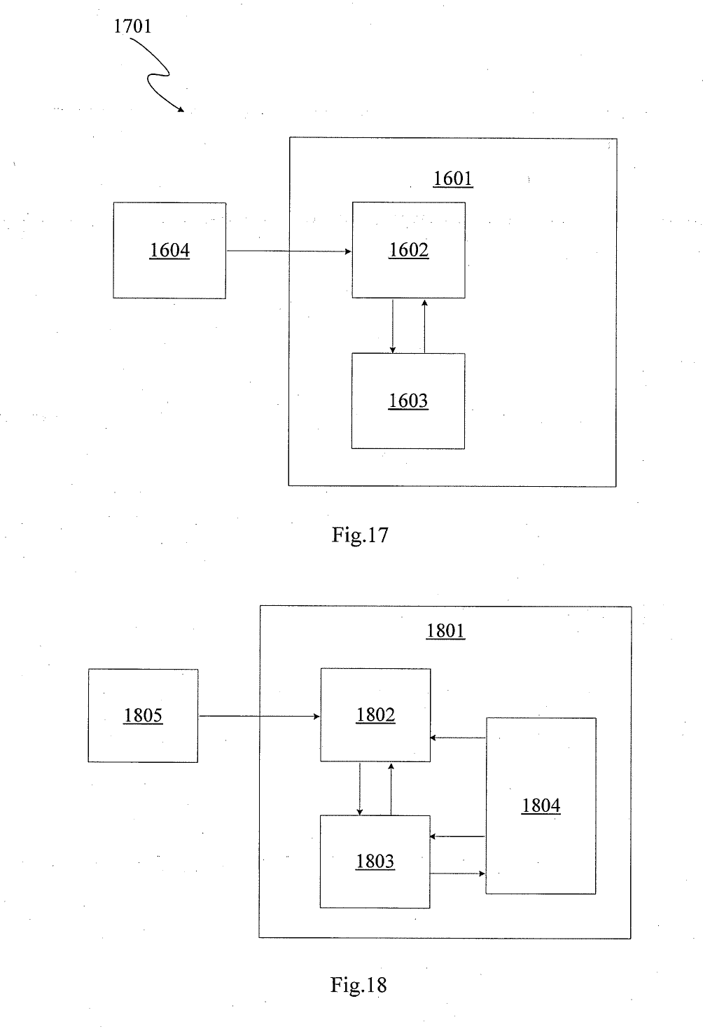

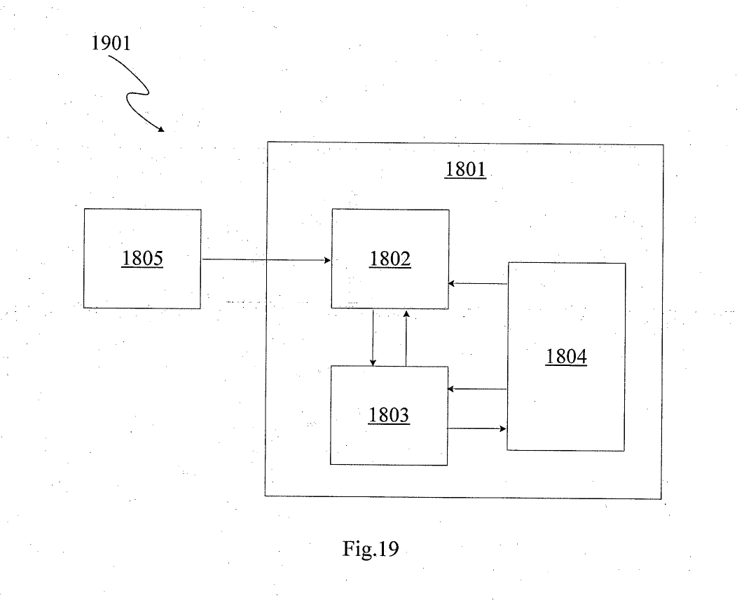

FIG. 9 illustrates a flow chart of another variation of the embodiment illustrated in FIG. 7, and as illustrated, FIG. 9 differs from FIG. 7 in that the step 709′ includes increasing the first predetermined value by a first constant, for example, by a constant of 1, and this step makes the first predetermined value looser each time another set of outputs is read. This step is particularly useful in the case that the zero-bias error of the gyroscope drifts due to a change in ambient temperature, a change in peripheral circuit, degradation of the gyroscope itself or other external or internal factors. For example, in the case that the zero-bias error of the gyroscope and also output noise of the gyroscope is increased with rising ambient temperature, the first predetermined value is loosen each time another set of outputs is read, so the dispersion degree of the outputs in a high temperature environment can be less than the gradually increased first predetermined value even if the dispersion degree in the high temperature environment is increased, and thus the zero-bias error in the high temperature environment can be updated.

Thus the embodiment in FIG. 9 further allows the zero-bias error of the gyroscope to be updated to the current value in the case that the zero-bias error drifts and also the disperse degree of the outputs is increased in addition to the achieved advantages of the embodiments in FIG. 7.

It shall be noted that the “constant” in the step 709′ can be any appropriate value and can be adjusted as needed in practice. For example, the constant can be set relatively large in an application with an expected significant change in ambient temperature so that it will be more “easier” to update the average of the outputs with a changing dispersion degree to a zero-bias error.

It shall be further noted that the performing of the operation of “increasing the first predetermined value by a first constant” will not be limited to the step 709, but this operation can be performed at any appropriate moment in the method of determining a zero-bias error of a gyroscope according to the invention.

FIG. 10 illustrates an illustrative flow chart of the step 709 in the embodiment illustrated in FIG. 7, and as illustrated, the step 709 includes the sub-steps 1001, 1002 and 1003.

It is determined in the step 1001 whether a time interval is greater than a first predetermined time period, and the step 1002 is performed to read outputs from the gyroscope and to put them into a queue if the time interval is greater than the first predetermined time period, or the process continues with waiting if the time interval is no greater than the first predetermined time period. Next it is determined in the step 1003 whether the queue, in which the outputs of the gyroscope are stored, is full. If the queue is full, it indicates that there are sufficient sampling points and the step 703 is performed. The first predetermined time period is set to ensure that the sampling points will not be too dense.

FIG. 11 illustrates a graph of a zero-bias error of a gyroscope determined in real time using the method in FIG. 10, wherein the black line in FIG. 11(a) represents a Y-axis output of the gyroscope at temperature charging from 30° C. to 40° C. further to 20° C., and the white line represents a curve of a Y-axis zero-bias error determined using the method in FIG. 10; and the black line in FIG. 11(b) represents a Z-axis output of the gyroscope at temperature charging from 30° C. to 40° C. further to 20° C., and the white line represents a curve of a Z-axis zero-bias error determined using the method in FIG. 10. As can be apparent, the determined zero-bias error curves perfectly follow the change in temperature.

FIG. 12 illustrates a block diagram of an embodiment of an apparatus for determining a zero-bias error of a gyroscope according to another aspect of the invention. As illustrated, the apparatus 1201 for determining the zero-bias error of the gyroscope includes a receiving unit 1202 and a processing unit 1203 coupled to the receiving unit 1202. The operation of the apparatus 1201 will be described in connection with FIG. 3.

The receiving unit 1202 coupled to the gyroscope 1204 obtains a set of outputs from the gyroscope 1204 in the step 301. It shall be noted that the outputs of the gyroscope 1204 can be transmitted over a wired transmission medium, e.g., a cable, an optic fiber, etc., to the receiving unit 1202, or can be transmitted over a wireless transmission medium, e.g., a microwave, etc., to the receiving unit 1202. It shall further be noted that the outputs of the gyroscope 1204 can be transmitted from the gyroscope 1204 to the receiving unit 1202 directly or can be stored in a queue or stack of a memory (not illustrated) coupled between the gyroscope 1204 and the receiving unit 1202 and subsequently transmitted to the receiving unit 1202. The receiving unit 1202 can be, for example, an I/O port coupled to an external memory including a queue in which the outputs from the gyroscope 1204 are stored, and the processing unit 1203 enables to the I/O port to obtain the outputs of the gyroscope 1204 from the queue of the memory when the test of the zero-bias error is performed.

Then the processing unit 1203 determines a dispersion degree of the outputs in the step 303. Those skilled in the art can appreciate that there can be various methods of characterizing the dispersion degree of a set of data, e.g., as a variance, a standard deviation, a sum of squares of deviation from mean, etc., and the dispersion degree of the outputs of the gyroscope can be determined in any method, of characterizing a dispersion degree of data, as known or as developed after the filing date of this invention. In an example, a set of outputs of the gyroscope includes 10 sampling points {X1, X2, . . . , X10}, and the dispersion degree of this set of outputs is determined using a standard deviation, where the dispersion degree α is represented in the equation of:

$$α = \sqrt{{\sum }_{i = 1}^{10} {( Xi - X )}^{2} / 9} ,$$

Where X is an arithmetic mean of these 10 sampling points.

Next the processing unit 1203 determines whether the dispersion degree satisfies a predetermined condition in the step 305. In this flow chart, the step 305 is illustrated as determining whether the dispersion degree is less than a first predetermined value, so the predetermined condition is being less than the first predetermined value in this example, wherein the first predetermined value can be a constant determined as needed in practice. For example, the first predetermined value can be set relatively small, that is, the predetermined condition is relatively strict, in the case that it is required that a zero-bias test can be performed on the gyroscope only if it is at “absolute” rest; and it will be considered that the gyroscope is not at sufficient rest or that there is considerable interference around if the dispersion degree of the outputs is greater than the first predetermined value, and thus no zero-bias test will be performed on the gyroscope. The first predetermined value can be set relatively large, that is, the predetermined condition is relatively loose, in the case that it is required that a zero-bias test can be performed on the gyroscope as long as it is at “almost” rest.

The processing unit 1203 performs the step 307 to determine an average of the outputs as the zero-bias error of the gyroscope if the predetermined condition is satisfied based on the result of the determination in the step 305; and on the contrary, the processing unit 1203 performs the step 309 to obtain another set of outputs of the gyroscope and to repeat performing the steps 303 to 305 on the another set of outputs if the predetermined condition is not satisfied, wherein the average of the outputs can be any mathematic quantity, representing an average of a set of data, as known or as developed after the filing date of this invention.

In the embodiment illustrated in FIG. 12, the apparatus 1201 determines whether the dispersion degree of a set of outputs satisfies a predetermined condition, so the apparatus 1201 can be applicable to scenarios with different test requirements by changing the predetermined condition.

Moreover the apparatus 1201 determines the dispersion degree of a set of outputs to thereby prevent excessive noise from being introduced to the outputs due to mechanical vibration, electromagnetic interference and other reasons, thus ensuring that the set of outputs reflects a rest status without any occasional event occurring and thus a derived zero-bias error is closer to a true value.

It shall be noted that the predetermined condition can be in various forms, and the processing unit 1203 can determine whether the dispersion degree of the outputs of the gyroscope is no greater than a first predetermined value in the step 305.

Those skilled in the art shall appreciate that the processing unit 1203 can be achieved by any hardware as known or as developed after the filing date of this invention, e.g., an MCU, an FPGA, a DSP, etc.

In an embodiment, there is provided a system 1301, and as illustrated in FIG. 13, the system includes the gyroscope 1204 and the apparatus 1201 for determining the error of the gyroscope as illustrated in FIG. 12.

FIG. 14 illustrates a block diagram of another embodiment of an apparatus for determining a zero-bias error of a gyroscope according to another aspect of the invention. As illustrated, the apparatus 1401 for determining the zero-bias error of the gyroscope includes a receiving unit 1402, a calculating unit 1403 coupled to the receiving unit 1402, and a determining unit 1404 coupled to the receiving unit 1402 and the calculating unit 1403. The operation of the apparatus 1401 will be described in connection with FIG. 3.

The receiving unit 1402 coupled to the gyroscope 1405 obtains a set of outputs from the gyroscope 1405 in the step 301. It shall be noted that the outputs of the gyroscope 1405 can be transmitted over a wired transmission medium, e.g., a cable, an optic fiber, etc., to the receiving unit 1402, or can be transmitted over a wireless transmission medium, e.g., a microwave, etc., to the receiving unit 1402. It shall further be noted that the outputs of the gyroscope 1405 can be transmitted from the gyroscope 1405 to the receiving unit 1402 directly or can be stored in a queue or stack of a memory (not illustrated) coupled between the gyroscope 1405 and the receiving unit 1402 and subsequently transmitted to the receiving unit 1402. The receiving unit 1402 can be, for example, an I/O port coupled to an external memory including a queue in which the outputs from the gyroscope 1405 are stored, and the determining unit 1404 enables to the I/O port to obtain the outputs of the gyroscope 1405 from the queue of the memory when the test of the zero-bias error is performed.

Then the calculating unit 1403 determines a dispersion degree of the outputs in the step 303.

Next the determining unit 1404 receives the dispersion degree of the outputs determined by the calculating unit 1403, determines whether the dispersion degree satisfies a predetermined condition and provides the result of the determination to the receiving unit 1402 or the calculating unit 1403 in the step 305. In this flow chart, the step 305 is illustrated as determining whether the dispersion degree is less than a first predetermined value, so the predetermined condition is being less than the first predetermined value in this example.

The determining unit 1404 provides the result of the determination to the calculating unit 1403 if the result of the determination is that the dispersion degree satisfies the predetermined condition, and the calculating unit 1403 performs the step 307 to determine an average of the outputs as the zero-bias error of the gyroscope.

The determining unit 1404 provides the result of the determination to the receiving unit 1402 if the result of the determination is that the dispersion degree does not satisfy the predetermined condition, and the receiving unit 1402 performs the step 309 to obtain another set of outputs of the gyroscope 1405, and further the calculating unit 1403 and the determining unit 1404 repeat performing the steps 303 to 305 on the another set of outputs.

In an embodiment, there is provided a system 1501, and as illustrated in FIG. 15, the system includes the gyroscope 1405 and the apparatus 1401 for determining the error of the gyroscope as illustrated in FIG. 14.

FIG. 16 illustrates a block diagram of another embodiment of an apparatus for determining a zero-bias error of a gyroscope according to another aspect of the invention. As illustrated, the apparatus 1601 for determining a zero-bias error of a gyroscope includes a receiving unit 1602 and a processing unit 1603 coupled to the receiving unit 1602. The operation of the apparatus 1601 will be described in connection with FIG. 7.

The receiving unit 1602 coupled to the gyroscope 1604 obtains a set of outputs from the gyroscope 1604 in the step 701. It shall be noted that the outputs of the gyroscope 1604 can be transmitted over a wired transmission medium, e.g., a cable, an optic fiber, etc., to the receiving unit 1602, or can be transmitted over a wireless transmission medium, e.g., a microwave, etc., to the receiving unit 1602. It shall further be noted that the outputs of the gyroscope 1604 can be transmitted from the gyroscope 1604 to the receiving unit 1602 directly or can be stored in a queue or stack of a memory (not illustrated) coupled between the gyroscope 1604 and the receiving unit 1602 and subsequently transmitted to the receiving unit 1602. The receiving unit 1602 can be, for example, an I/O port coupled to an external memory including a queue in which the outputs from the gyroscope 1604 are stored, and the processing unit 1603 enables to the I/O port to obtain the outputs of the gyroscope 1604 from the queue of the memory when the test of the zero-bias error is performed.

Then the processing unit 1603 determines a dispersion degree of the outputs in the step 703. Those skilled in the art can appreciate that there can be various methods of characterizing the dispersion degree of a set of data, e.g., as a variance, a standard deviation, a sum of squares of deviation from mean, etc., and the dispersion degree of the outputs of the gyroscope can be determined in any method, of characterizing a dispersion degree of data, as known or as developed after the filing date of this invention. In an example, a set of outputs of the gyroscope includes 10 sampling points {X1, X2, . . . , X10}, and the dispersion degree of this set of outputs is determined using a standard deviation, where the dispersion degree α is represented in the equation of:

$$α = \sqrt{{\sum }_{i = 1}^{10} {( Xi - X )}^{2} / 9} ,$$

Where X is an arithmetic mean of these 10 sampling points.

Next the processing unit 1603 determines whether the dispersion degree satisfies a predetermined condition in the step 705. In this flow chart, the step 705 is illustrated as determining whether the dispersion degree is less than a first predetermined value, so the predetermined condition is being less than the first predetermined value in this example, wherein the first predetermined value can be a constant determined as needed in practice. For example, the first predetermined value can be set relatively small, that is, the predetermined condition is relatively strict, in the case that it is required that a zero-bias test can be performed on the gyroscope only if it is at “absolute” rest; and it will be considered that the gyroscope is not at sufficient rest or that there is considerable interference around if the dispersion degree of the outputs is greater than the first predetermined value, and thus no zero-bias test will be performed on the gyroscope. The first predetermined value can be set relatively large, that is, the predetermined condition is relatively loose, in the case that it is required that a zero-bias test can be performed on the gyroscope as long as it is at “almost” rest.

The processing unit 1603 performs the step 707 to determine an average of the outputs as the zero-bias error of the gyroscope and to update the predetermined condition based on the dispersion degree if the predetermined condition is satisfied based on the result of the determination in the step 705, wherein when the predetermined condition is being less than a first predetermined value, the processing unit 1603 updates the predetermined condition based on the dispersion degree by updating the first predetermined value with the dispersion degree. The processing unit 1603 further performs the step 709, subsequent to the performing of the step 707, to receive another set of outputs of the gyroscope 1604 from the receiving unit 1602 and to repeat performing the steps 703 to 705 on the another set of outputs.

The processing unit 1603 performs the step 709 to obtain another set of outputs of the gyroscope from the receiving unit 1602 and to repeat performing the steps 703 to 705 on the another set of outputs if the predetermined condition is not satisfied based on the result of the determination in the step 705, wherein the average of the outputs can be any mathematic quantity, representing an average of a set of data, as known or as developed after the filing date of this invention.

In the embodiment illustrated in FIG. 16, the processing unit 1603 determines whether the dispersion degree of a set of outputs satisfies a predetermined condition, so the apparatus 1601 for determining a zero-bias error of a gyroscope can be applicable to scenarios with different test requirements by changing the predetermined condition.

Moreover the processing unit 1603 determines the dispersion degree of a set of outputs to thereby prevent excessive noise from being introduced to the outputs due to mechanical vibration, electromagnetic interference and other reasons, thus ensuring that the set of outputs reflects a rest status without any occasional event occurring and thus a derived zero-bias error is closer to a true value.

Moreover the apparatus 1601 allows a test to be started on the gyroscope still in motion, and the zero-bias error derived by the apparatus 1601 will constantly approach a true value as the gyroscope approaches rest. This process will be described in details as follows: the first predetermined value is set infinite or sufficiently large, and thus the processing unit 1603 determines the dispersion degree of the outputs of the gyroscope is less than the first predetermined value in the step 705 and thereby defines the first predetermined value as the dispersion degree of the outputs and determines the average of the outputs as the zero-bias error in the step 707. If the gyroscope approaches rest, the dispersion degree of the further obtained set of outputs of the gyroscope will be smaller and smaller until the gyroscope comes to rest and the dispersion degree reaches the minimum. In the step 707, the processing unit 1603 defines the first predetermined value as the minimum dispersion degree of the outputs and determines the average of the outputs corresponding to this status as the zero-bias error. If the gyroscope subsequently goes back to instability, the dispersion degree of the outputs of the gyroscope is larger than the first predetermined value, and thus the zero-bias error will be maintained at the average of the outputs of the gyroscope at rest

Moreover the apparatus 1601 can be used to determine a zero-bias error of a gyroscope in real time, and the apparatus 1601 can track a change in the zero-bias error of the gyroscope in the case that the zero-bias error of the gyroscope becomes smaller, for example, in the case that a peripheral circuit of the gyroscope is replaced or in the case of lowered ambient temperature.

It shall be noted that the predetermined condition can be in various forms, and the processing unit 1603 can determine whether the dispersion degree of the outputs of the gyroscope is no greater than a first predetermined value in the step 705′.

In an embodiment, the processing unit 1603 is further configured to increase the first predetermined value by a first constant. Referring to FIG. 9, the processing unit 1603 performs the step 709′ to increase the first predetermined value by a first constant, for example, by a constant of 1, thereby making the first predetermined value looser each time another set of outputs is read. This is particularly useful in the case that the zero-bias error of the gyroscope drifts due to a change in ambient temperature, a change in peripheral circuit, degradation of the gyroscope itself or other external or internal factors. For example, in the case that the zero-bias error of the gyroscope and also output noise of the gyroscope is increased with rising ambient temperature, the first predetermined value is loosen each time another set of outputs is read, so a dispersion degree of the outputs in a high temperature environment can be less than the gradually increased first predetermined value even if the dispersion degree in the high temperature environment is increased, and thus the zero-bias error in the high temperature environment can be updated.

Thus the apparatus 1601 further allows the zero-bias error of the gyroscope to be updated to the current value in the case that the zero-bias error drifts and also the disperse degree of the outputs is increased.

It shall be noted that the “constant” can be any appropriate value and can be adjusted as needed in practice. For example, the constant can be set relatively large in an application with an expected significant change in ambient temperature so that it will be more “easier” to update the average of the outputs with a changing dispersion degree to a zero-bias error.

Those skilled in the art shall appreciate that the processing unit 1603 can be embodied in any hardware as known or as developed after the filing date of this invention, e.g., an MCU, an FPGA, a DSP, etc.

In an embodiment, there is provided a system 1701, and as illustrated in FIG. 17, the system includes the gyroscope 1604 and the apparatus 1601 for determining an error of the gyroscope as illustrated in FIG. 16.

FIG. 18 illustrates a block diagram of another embodiment of an apparatus for determining a zero-bias error of a gyroscope. As illustrated, the apparatus 1801 for determining a zero-bias error of a gyroscope includes a receiving unit 1802, a calculating unit 1803 coupled to the receiving unit 1802, and a determining unit 1804 coupled to the receiving unit 1802 and the calculating unit 1803. The operation of the apparatus 1801 will be described in connection with FIG. 7.

The receiving unit 1802 coupled to the gyroscope 1805 obtains a set of outputs from the gyroscope 1805 in the step 701. It shall be noted that the outputs of the gyroscope 1805 can be transmitted over a wired transmission medium, e.g., a cable, an optic fiber, etc., to the receiving unit 1802, or can be transmitted over a wireless transmission medium, e.g., a microwave, etc., to the receiving unit 1802. It shall further be noted that the outputs of the gyroscope 1805 can be transmitted from the gyroscope 1805 to the receiving unit 1802 directly or can be stored in a queue or stack of a memory (not illustrated) coupled between the gyroscope 1805 and the receiving unit 1802 and subsequently transmitted to the receiving unit 1802. The receiving unit 1802 can be, for example, an I/O port coupled to an external memory including a queue in which outputs from the gyroscope 1805 are stored, and the determining unit 1804 enables to the I/O port to obtain the outputs of the gyroscope 1805 from the queue of the memory when the test of the zero-bias error is performed.

Then the calculating unit 1803 determines a dispersion degree of the outputs in the step 703.

Next the determining unit 1804 determines whether the dispersion degree satisfies a predetermined condition. In this flow chart, the step 705 is illustrated as determining whether the dispersion degree is less than a first predetermined value, so the predetermined condition is being less than the first predetermined value in this example.

The determining unit 1804 provides the result of the determination in the step 705 to the calculating unit 1803 if the predetermined condition is satisfied based on the result of the determination, and the calculating unit 1803 performs the step 707 to determine an average of the outputs as the zero-bias error of the gyroscope and to update the predetermined condition based on the dispersion degree, wherein when the predetermined condition is being less than a first predetermined value, the calculating unit 1803 updates the predetermined condition based on the dispersion degree by updating the first predetermined value with the dispersion degree. The calculating unit 1803 further performs the step 709, subsequent to the performing of the step 707, to obtain another set of outputs of the gyroscope 1805 from the receiving unit 1802 and to repeat performing the steps 703 to 705 on the another set of outputs.

The determining unit 1804 provides the result of the determination in the step 705 to the receiving unit 1802 if the predetermined condition is not satisfied based on the result of the determination, and the receiving unit 1802 performs the step 709 to obtain another set of outputs from the gyroscope 1805 and to repeat performing the steps 703 to 705 on the another set of outputs.

In an embodiment, the calculating unit 1803 is further configured to increase the first predetermined value by a first constant. Referring to FIG. 9, the calculating unit 1803 performs the step 709′ to increase the first predetermined value by a first constant, for example, by a constant of 1, thereby making the first predetermined value looser each time another set of outputs is read. This is particularly useful in the case that the zero-bias error of the gyroscope drifts due to a change in ambient temperature, a change in peripheral circuit, degradation of the gyroscope itself or other external or internal factors. For example, in the case that the zero-bias error of the gyroscope and also output noise of the gyroscope is increased with rising ambient temperature, the first predetermined value is loosen each time another set of outputs is read, so a dispersion degree of the outputs in a high temperature environment can be less than the gradually increased first predetermined value even if the dispersion degree in the high temperature environment is increased, and thus the zero-bias error in the high temperature environment can be updated.

Thus the apparatus 1801 further allows the zero-bias error of the gyroscope to be updated to the current value in the case that the zero-bias error drifts and also the disperse degree of the outputs is increased.

It shall be noted that the “constant” can be any appropriate value and can be adjusted as needed in practice. For example, the constant can be set relatively large in an application with an expected significant change in ambient temperature so that it will be more “easier” to update the average of the outputs with a changing dispersion degree to a zero-bias error.

In an embodiment, there is provided a system 1901, and as illustrated in FIG. 19, the system includes the gyroscope 1805 and the apparatus 1801 for determining an error of the gyroscope as illustrated in FIG. 18.

In this disclosure, reference can be made to the description of the method embodiments for functioning of the apparatus embodiments for a demonstrative purpose. However it shall be appreciated that the functioning of the apparatus and the implementation of the method in the disclosure will be impendent of each other. In other words, the disclosed apparatus embodiments can function in an alternative method, and the disclosed method embodiments can be implemented in an alternative apparatus.

Those skilled in the art will further readily appreciate that the material and the method can be varied without departing from the scope of the invention. It shall further be appreciated that the invention provides various applicable innovative ideas in addition to the illustrated specific context of the embodiments. Thus the appended claims are intended to encompass in their scope these processes, machines, articles of manufacture, compositions, means, methods or steps.

1. A method of determining a zero-bias error of a gyroscope, the method comprising the steps of:
a. obtaining a set of outputs of the gyroscope;
b. determining a dispersion degree of the outputs;
c. determining whether the dispersion degree satisfies a predetermined condition and performing the step of d or e based upon a result of the determination; and
d. determining an average of the outputs as the zero-bias error of the gyroscope when the dispersion degree satisfies the predetermined condition; or
e. obtaining another set of outputs of the gyroscope and repeating performing the steps of b to c on the another set of outputs when the dispersion degree does not satisfy the predetermined condition.

2. The method according to claim 1, wherein the predetermined condition comprises at least one of:
being less than a first predetermined value; and
being no greater than the first predetermined value.

3. The method according to claim 1, wherein the dispersion degree is a standard deviation.

4. The method according to claim 1, wherein the average is an arithmetic mean.

5. The method according to claim 1, wherein sampling points in two obtained adjacent sets of outputs are partially identical.

6. The method according to claim 2, wherein the first predetermined value is a constant.

7. A method of determining a zero-bias error of a gyroscope, the method comprising the steps of:
a. obtaining a set of outputs of the gyroscope;
b. determining a dispersion degree of the outputs;
c. determining whether the dispersion degree satisfies a predetermined condition and performing the step of d or e based upon a result of the determination;
d. determining an average of the outputs as the zero-bias error of the gyroscope and updating the predetermined condition based upon the dispersion degree and further performing the step of f when the dispersion degree satisfies the predetermined condition; or
e. performing the step of f directly when the dispersion degree does not satisfy the predetermined condition; and
f. obtaining another set of outputs of the gyroscope and repeating performing the steps of b to f on the another set of outputs.

8. The method according to claim 7, wherein the predetermined condition comprises at least one of:
being less than a first predetermined value; and
being no greater than the first predetermined value, and
wherein the step of updating the predetermined condition based upon the dispersion degree in the step of d comprises: updating the first predetermined value with the dispersion degree.

9. The method according to claim 8, wherein the step of f further comprises the step of:
increasing the first predetermined value by a first constant.

10. The method according to claim 7, wherein the dispersion degree is a standard deviation.

11. The method according to claim 7, wherein the average is an arithmetic mean.

12. The method according to claim 7, wherein sampling points in two obtained adjacent sets of outputs are partially identical.

13. The method according to claim 7, wherein respective sampling points in the outputs are read from the gyroscope at an interval of a first predetermined time period.

14. An apparatus for determining a zero-bias error of a gyroscope, the apparatus comprising:
a receiving unit configured to obtain a set of outputs from the gyroscope;
a processing unit coupled to the receiving unit to receive the outputs and configured to
determine a dispersion degree of the outputs;
determine whether the dispersion degree satisfies a predetermined condition; and
determine an average of the outputs as the zero-bias error of the gyroscope when the dispersion degree satisfies the predetermined condition; or
control the receiving unit to obtain another set of outputs from the gyroscope when the dispersion degree does not satisfy the predetermined condition.

15. The apparatus according to claim 14, wherein the predetermined condition comprises at least one of:
being less than a first predetermined value; and
being no greater than the first predetermined value.

16. A system, comprising:
a gyroscope; and
an apparatus for determining a zero-bias error of the gyroscope according to claim 14 or 15, the apparatus being coupled to the gyroscope.

17. An apparatus for determining a zero-bias error of a gyroscope, the apparatus comprising:
a receiving unit configured to obtain a set of outputs from the gyroscope;
a calculating unit coupled to the receiving unit to receive the outputs and configured to calculate a dispersion degree of the outputs based upon the outputs; and
a determining unit coupled to the calculating unit to receive the dispersion degree and configured to determine whether the dispersion degree satisfies a predetermined condition and to provide a result of the determination to the receiving unit or the calculating unit;
wherein the calculating unit is configured to determine an average of the outputs as the zero-bias error of the gyroscope in response to the result of the determination when the result of the determination is that the dispersion degree satisfies the predetermined condition, or the receiving unit is configured to obtain another set of outputs from the gyroscope in response to the result of the determination when the result of the determination is that the dispersion degree does not satisfy the predetermined condition.

18. The apparatus according to claim 17, wherein the predetermined condition comprises at least one of:
being less than a first predetermined value; and
being no greater than the first predetermined value.

19. A system, comprising:
a gyroscope; and
an apparatus for determining a zero-bias error of the gyroscope according to claim 17 or 18, the apparatus being coupled to the gyroscope.

20. A apparatus for determining a zero-bias error of a gyroscope, the apparatus comprising:
a receiving unit configured to obtain a set of outputs from the gyroscope;
a processing unit coupled to the receiving unit to receive the outputs and configured to
determine a dispersion degree of the outputs;
determine whether the dispersion degree satisfies a predetermined condition; and
determine an average of the outputs as the zero-bias error of the gyroscope and update the predetermined condition based upon the dispersion degree and further control the receiving unit to obtain another set of outputs from the gyroscope when the dispersion degree satisfies the predetermined condition; or
control the receiving unit to obtain another set of outputs from the gyroscope when the dispersion degree does not satisfy the predetermined condition.

21. The apparatus according to claim 20, wherein the predetermined condition comprises at least one of:
being less than a first predetermined value; and
being no greater than the first predetermined value,
wherein the processing unit updating the predetermined condition based upon the dispersion degree comprises: updating the first predetermined value with the dispersion degree.

22. The apparatus according to claim 21, wherein the processing unit is further configured to increase the first predetermined value by a first constant.

23. A system, comprising:
a gyroscope; and
an apparatus for determining a zero-bias error of the gyroscope according to the claim 20 or 21, the apparatus being coupled to the gyroscope.

24. An apparatus for determining a zero-bias error of a gyroscope, the apparatus comprising:
a receiving unit configured to obtain a set of outputs from the gyroscope;
a calculating unit coupled to the receiving unit to receive the outputs and configured to calculate a dispersion degree of the outputs based upon the outputs; and
a determining unit coupled to the calculating unit to receive the dispersion degree and configured to determine whether the dispersion degree satisfies a predetermined condition and to provide a result of the determination to the receiving unit or the calculating unit;
wherein the calculating unit is configured to determine an average of the outputs as the zero-bias error of the gyroscope in response to the result of the determination and to update the predetermined condition based upon the dispersion degree and further the receiving unit is configured to obtain another set of outputs from the gyroscope when the result of the determination is that the dispersion degree satisfies the predetermined condition; or the receiving unit is configured to obtain another set of outputs from the gyroscope in response to the result of the determination when the result of the determination is that the dispersion degree does not satisfy the predetermined condition.

25. The apparatus according to claim 24, wherein the predetermined condition comprises at least one of:
being less than a first predetermined value; and
being no greater than the first predetermined value,
wherein the calculating unit updating the predetermined condition based upon the dispersion degree comprises: updating the first predetermined value with the dispersion degree.

26. The apparatus according to claim 24, wherein the calculating unit is further configured to increase the first predetermined value by a first constant.

27. A system, comprising:
a gyroscope; and
an apparatus for determining a zero-bias error of the gyroscope according to the claim 24 or 25, the apparatus being coupled to the gyroscope.
